(19) United States
(12) Patent Application Publication
(10) Pub. No.: US 2024/0119106 A1
(43) Pub. Date: Apr. 11, 2024

(54) MULTIVARIATE NORMALIZATION OF WELL LOGS USING PROBABILITY DISTRIBUTION MODELING

(71) Applicant: Chevron U.S.A. Inc., San Ramon, CA (US)

(72) Inventors: Mason C. Edwards, Houston, TX (US); Kevin Kaczorowski, Houston, TX (US); Paymon Hossaini, Cypress, TX (US)

(21) Appl. No.: 17/963,559

(22) Filed: Oct. 11, 2022

(51) Int. Cl. G06F 17/11; G06F 7/50

(52) U.S. Cl. CPC G06F 17/11; G06F 7/50

(57) ABSTRACT

Application logs to be normalized may be grouped into (1) mutable logs to be changed through normalization, and (2) context logs that remain constant. Reference logs may be grouped into same types of logs. Multivariate linear transformation may be performed on the application logs using the reference logs, with the parameters of the multivariate linear transformation adjusted based on comparison of the probability distribution of reference logs with the probability distribution of normalized application logs.

### FIELD

The present disclosure relates generally to the field of well log normalization using multivariate linear transformation.

### BACKGROUND

Well logs may be measured to capture signals that reflect subsurface properties of a subsurface region. Tools and/or calibration used in measuring well logs may introduce noise into the well logs, and normalization may be applied to remove such noise. However, normalization of well logs to reference logs in univariate space, such as via histogram matching, may result in geologically significant signals being removed from the well logs and/or well log combinations not being petrophysically consistent.

### SUMMARY

This disclosure relates to well log normalization. Application log information, reference log information, and/or other information may be obtained. The application log information may define one or more sets of application logs. The set(s) of application logs may include application mutable logs, application context logs, and/or other application logs. The application mutable logs may include application logs to be changed in the well log normalization. The application context logs may include application logs not to be changed in the well log normalization. The reference log information defining one or more sets of reference logs. The set(s) of reference logs may include reference mutable logs, reference context logs, and/or other reference logs. The reference mutable logs may correspond to the application mutable logs and the reference context logs may correspond to the application context logs. One or more sets of normalized application logs may be generated based on a multivariate linear transformation of the set(s) of application logs using the set(s) of reference logs and/or other information. The multivariate linear transformation of the set(s) of application logs may change the application mutable logs in the set(s) of normalized application logs. The multivariate linear transformation of the set(s) of application logs may not change the application context logs in the set(s) of normalized application logs.

A system for well log normalization may include one or more electronic storage, one or more processors and/or other components. The electronic storage may store application log information, information relating to application logs, information relating to application mutable logs, information relating to application context logs, reference log information, information relating to reference mutable logs, information relating to reference context logs, information relating to multivariate linear transformation, information relating to normalized application logs, and/or other information.

The processor(s) may be configured by machine-readable instructions. Executing the machine-readable instructions may cause the processor(s) to facilitate well log normalization. The machine-readable instructions may include one or more computer program components. The computer program components may include one or more of an application log component, a reference log component, a normalization component, and/or other computer program components.

The application log component may be configured to obtain application log information and/or other information. The application log information may define one or more sets of application logs. The set(s) of application logs may include application mutable logs, application context logs, and/or other application logs. The application mutable logs may include application logs to be changed in the well log normalization. The application context logs may include application logs not to be changed in the well log normalization. In some implementations, the application log information may be derived from a single application well.

The reference log component may be configured to obtain reference log information and/or other information. The reference log information may define one or more sets of reference logs. The set(s) of reference logs may include reference mutable logs, reference context logs, and/or other reference logs. The reference mutable logs may correspond to the application mutable logs. The reference context logs may correspond to the application context logs. In some implementations, the reference log information may be derived from one or more reference wells.

The normalization component may be configured to generate one or more sets of normalized application logs. The set(s) of normalized application logs may be generated based on a multivariate linear transformation of the set of application logs using the set of reference logs and/or other information. The multivariate linear transformation of the set(s) of application logs may change the application mutable logs in the set(s) of normalized application logs. The multivariate linear transformation of the set(s) of application logs may not change the application context logs in the set(s) of normalized application logs.

In some implementations, the multivariate linear transformation of a set of application logs may be adjusted based on difference between a probability distribution of a set of normalized application logs and a probability distribution of a set of reference logs, and/or other information. The set of application logs may be represented within a data matrix for the multivariate linear transformation. Adjustment of the multivariate linear transformation of the set of application logs may include change in values of a transformation matrix and/or a bias vector. Change in the values of the transformation matrix and the bias vector may reduce the difference between the probability distribution of the set of normalized application logs and the probability distribution of the set of reference logs.

In some implementations, components of a probability distribution of a set of reference logs may be reweighted to increase approximation of a probability distribution of a set of normalized application logs. In some implementations, reweighting of the components of the probability distribution of the set of reference logs to increase approximation of the probability distribution of the set of normalized application logs may include setting a weight of a given component of the probability distribution of the set of reference logs to zero to remove the given component based on a corresponding component not existing within the probability distribution of the set of normalized application logs and/or other information.

In some implementations, the difference between the probability distribution of a set of normalized application logs and the probability distribution of a set of reference logs may be quantified using Jensen-Shannon divergence.

In some implementations, the probability distribution of a set of normalized application logs and the probability distribution of a set of reference logs may be represented as sums of multiple elementary probability density functions. The probability distribution of the set of normalized application logs and the probability distribution of the set of reference logs may be represented as the sums of multiple elementary probability density functions using Gaussian mixture modeling and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for well log normalization.

FIG. 2 illustrates an example method for well log normalization.

FIG. 3 illustrates different normalizations of a well log.

FIG. 4 illustrates an example process for well log normalization.

FIG. 5 illustrates examples of reference probability distribution and normalized application probability distribution.

FIG. 6A illustrates an example multivariate linear transformation.

FIG. 6B illustrates example transformations.

FIG. 7A illustrates an example representation of a probability distribution as a sum of multiple elementary probability distribution functions.

FIG. 7B illustrates an example multivariate linear transformation.

FIG. 7C illustrates an example component weighting of a probability distribution.

FIG. 8 illustrates an example well log normalization.

FIG. 9 illustrates example changes in probability distribution after well log normalization.

### DETAILED DESCRIPTION

The present disclosure relates to well log normalization. Application logs to be normalized may be grouped into (1) mutable logs to be changed through normalization, and (2) context logs that remain constant. Reference logs may be grouped into same types of logs. Multivariate linear transformation may be performed on the application logs using the reference logs, with the parameters of the multivariate linear transformation adjusted based on comparison of the probability distribution of reference logs with the probability distribution of normalized application logs.

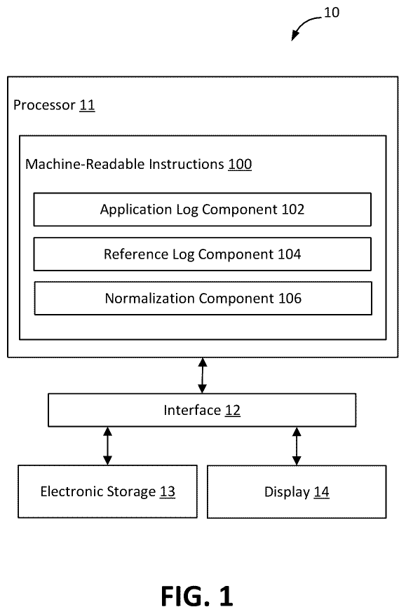

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a display 14, and/or other components. Application log information, reference log information, and/or other information may be obtained by the processor 11. The application log information may define one or more sets of application logs. The set(s) of application logs may include application mutable logs, application context logs, and/or other application logs. The application mutable logs may include application logs to be changed in the well log normalization. The application context logs may include application logs not to be changed in the well log normalization. The reference log information defining one or more sets of reference logs. The set(s) of reference logs may include reference mutable logs, reference context logs, and/or other reference logs. The reference mutable logs may correspond to the application mutable logs and the reference context logs may correspond to the application context logs. One or more sets of normalized application logs may be generated by the processor 11 based on a multivariate linear transformation of the set(s) of application logs using the set(s) of reference logs and/or other information. The multivariate linear transformation of the set(s) of application logs may change the application mutable logs in the set(s) of normalized application logs. The multivariate linear transformation of the set(s) of application logs may not change the application context logs in the set(s) of normalized application logs.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store application log information, information relating to application logs, information relating to application mutable logs, information relating to application context logs, reference log information, information relating to reference mutable logs, information relating to reference context logs, information relating to multivariate linear transformation, information relating to normalized application logs, and/or other information.

The display 14 may refer to an electronic device that provides visual presentation of information. The display 14 may include a color display and/or a non-color display. The display 14 may be configured to visually present information. The display 14 may present information using/within one or more graphical user interfaces. For example, the display 14 may present application log information, information relating to application logs, information relating to application mutable logs, information relating to application context logs, reference log information, information relating to reference mutable logs, information relating to reference context logs, information relating to multivariate linear transformation, information relating to normalized application logs, and/or other information.

The goal of well log measurement is to capture signals that that reflect subsurface properties of a subsurface region (e.g., petrophysical properties of a subsurface formation). Accurate assessment of a subsurface region, such as for identification of target zones, completion design optimization, and/or quantification of hydrocarbon-in-place, requires reliable well log measurement. However, a number of factors may cause well log measurement to become inaccurate. For example, wellbore conditions (e.g., caliper regularity and mud composition), operational factors (e.g., logging speed, tool calibration, and tool position relative to the borehole wall) may affect the quality of well log measurement.

Well log normalization may be performed to reduce (e.g., minimize) the impact of measurement anomalies. Well log normalization may reduce the negative influence of system errors present in well log measurement. Industry standard procedures for well log normalization utilize univariate space manipulation. An example well log normalization includes univariate histogram matching techniques (i.e., normalizing one measurement at a time) followed by quality checks using cross plots and overlays. Individual histograms selected for normalization may be compared against reference histograms obtained from other wells, core data, or field-scale geophysical analysis.

Univariate normalization of well logs, however, intrinsically neglects the covariance between different well logs caused by the underlying petrophysical properties. Univariate normalization of well logs may not account for/be able to correct noise in the well logs due to tools and/or calibration used in measuring well logs. Univariate normalization of well logs may generate artifacts in the normalized data, which may cause interpretation errors. Univariate normalization of well logs may make inaccurate assumptions about the well logs, such as assuming that underlying geology does not change, assuming that normalization can be achieved with a partial linear transform, and assuming that all differences between distributions of well logs are attributable to tool differences. Univariate normalization of well logs may remove geological significant differences between well logs that are normalized and well logs that are used as reference. Univariate normalization of well logs may result in well log combinations that are not petrophysically consistent. For example, different types of well logs being normalized independently of other types of well logs may result in the normalized well logs being petrophysically decoupled from each other. The normalized well logs may not accurately represent the petrophysical properties of the subsurface region.

The present disclosure provides a multivariate linear transformation technique to perform well log normalization. The well log normalized disclosed herein treats different well logs non-independently and allows normalization when well logs are sampled from depth subsets not representative of a full reference log dataset (e.g., allow for normalization when the application logs cover a subset of depths covered by the reference logs). The well log normalization disclosed herein inherently incorporates the covariance between different well logs, honors the underlying properties reflected in the well logs, and reduces subjectivity in well log normalization.

Well logs may include application logs, reference logs, and/or other well logs. Application logs may refer to well logs that require normalization. Application logs may refer to well logs to be normalized. Application logs may be referred to as application well logs. Reference logs may refer to well logs that are used as a reference to perform normalization of application logs. The probability distribution of reference log(s) (reference probability distribution) may be used to normalize the probability distribution of an application log (application probability distribution). A probability distribution of a well log may be represented as a sum of multiple element probability density functions. For example, a probability distribution of a well log may be represented as the superposition of multiple Gaussian kernels using Gaussian mixture modeling (GMM). A single probability distribution may be composed of multiple Gaussian components.

A multivariate linear transformation may be performed on the application probability distribution to approximate the reference probability distribution. The parameters of the multivariate linear transformation may be tuned to increase similarity between the normalized application probability distribution and the reference probability distribution. The parameters of the multivariate linear transformation may change how the application probability distribution is normalized, as well as change the reference probability distribution to which the normalized application probability distribution is compared. The reference probability distribution to which the normalized application probability distribution is compared may be changed via component reweighting. The reference probability distribution to which the normalized application probability distribution is compared may not be changed via the linear transformation.

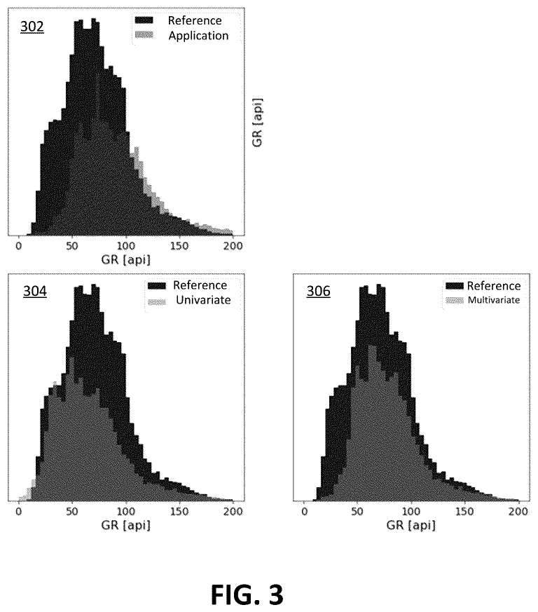

The results of the well log normalization disclosed herein demonstrate that statistical distributions of the normalized well logs are highly correlated with statistical distributions from the reference logs across different lithological zones (e.g., carbonate interval, shale interval, shaly sand interval. For example, FIG. 3 illustrates different normalizations of a well log. A plot 302 shows a reference probability distribution and an application probability distribution. A plot 304 shows the result of normalizing the application probability distribution using univariate normalization, such as independent histogram matchings of the 5% and 95% percentiles of the distributions. While univariate normalization may be capable of correcting tail ends of the probability distribution, intermediate sections of the probability distribution may not be adequately/accurately normalized. Inaccuracies generated by univariate normalization may result in inaccurate interpretation of subsurface properties (e.g., error in porosity and saturation estimates).

A plot 306 shows the results of normalization of the application probability distribution using multivariate normalization of the present disclosure. Multivariate normalization may correct both the tail ends and intermediate sections of the probability distribution. Multivariate normalization may enable accurate interpretation of subsurface properties.

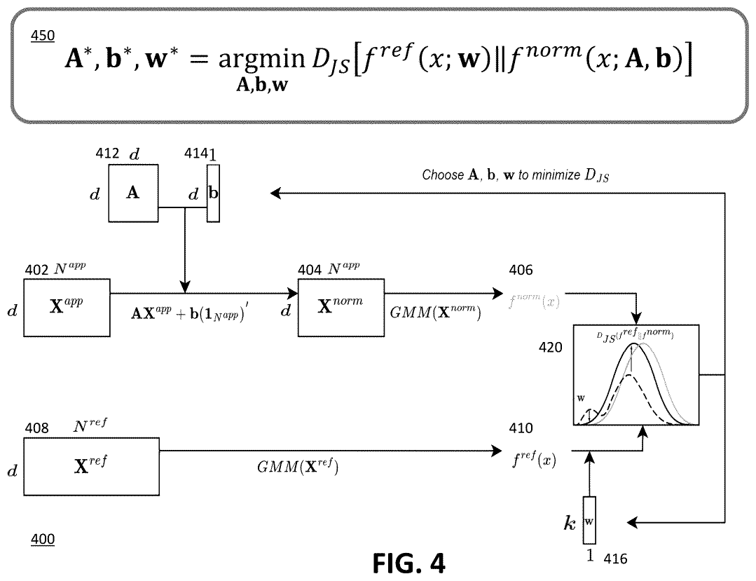

FIG. 4 illustrates an example process 400 for well log normalization. The goal of the process 400 may be to find a well log normalization transformation that, when applied to the probability distribution of application logs, causes the resulting normalized probability distribution to approximate the probability distribution of the reference logs (reduce/minimize difference between the normalized application probability distribution and the reference probability distribution).

An application dataset 402 (X^{app}) may include data from multiple types of application logs (application mutable logs, application context logs). A reference dataset 408 (X^{ref}) may include data from multiple types of reference logs (reference mutable logs, reference context logs). The datasets 402, 408 may be represented within matrices, with FIG. 4 showing the dimensionality of the matrices. N^{app} may be the number data points in the application dataset 402, and N^{ref} may be the number of data points in the reference dataset 408.

Normalization constants 412, 414 (transformation matrix A, bias vector b) may be selected and used to perform linear transformation of the application data set 402 and generate a normalized application dataset 404 (X^{norm}). The diagonal terms of the transformation matrix A may correspond to a linear scaling factor and the off-diagonal terms of the transformation matrix A may correspond to a rotation/shearing of the multidimensional distributions.

The probability distribution of the normalized application dataset 404 may be represented as a sum of multiple elementary probability density functions 406 (f^{norm}(x) normalized PDFs) using Gaussian mixture modeling. The probability distribution of the reference dataset 408 may be represented as a sum of multiple elementary probability density functions 410 (f^{ref}(x), reference PDFs) using Gaussian mixture modeling. Components (e.g., regions) of the reference PDFs may be weighted using weighting factors 416 (w).

Values of the normalization constants 412, 414 (transformation matrix A, bias vector b) and the weighting factors 416 (w) may be adjusted to reduce (e.g., minimize) the difference (e.g., Jensen-Shannon divergence) 420 between the normalized PDFs and the weighted reference PDFs. The values of the normalization constants 412, 414 (transformation matrix A, bias vector b) and the weighting factors 416 (w) may be adjusted until the difference between the normalized PDFs and the weighted reference PDFs satisfy one or more criteria (e.g., the difference falls below a threshold value, the difference is the minimum difference).

For example, an optimization 450 may be used to find the values of the normalization constants 412, 414 (transformation matrix A, bias vector b) and the weighting factors 416 (w). The difference (e.g., divergence) between reference probability distribution and the normalized application distribution may serve as the objective function in the optimization where the values of the normalization constants 412, 414 (transformation matrix A, bias vector b) and the weighting factors 416 (w) are selected to minimize the difference.

Weighting the components of the reference PDFs may enable the application dataset 402 to be accurately normalized even when the application dataset 402 falls within a subset of the reference dataset 408. For example, the reference dataset 408 may include data from depth ranges not included within the application dataset 402. Normalization of the application dataset 402 using the reference dataset 408 without weighting may result in inaccurate normalization.

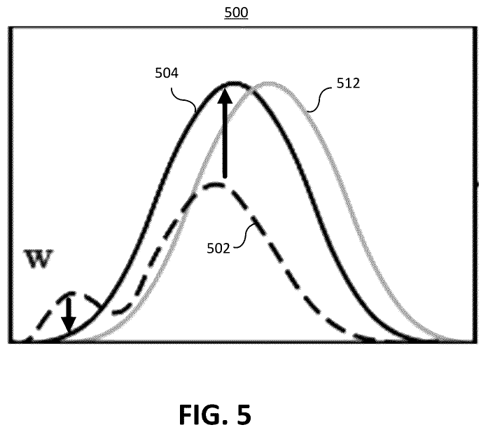

FIG. 5 illustrates examples of a reference probability distribution 502 (reference PDFs) and a normalized application probability distribution 512 (normalized PDFs). The difference in shapes of the reference probability distribution 502 and the normalized application probability distribution 512 may be due to the application logs representing underlying lithologies in proportions that differ from the reference logs. For example, the application logs may include data from a subset of depths with respect to the reference logs, resulting in the application logs not including data for all depths in the reference logs. Normalization of the application logs using the reference logs with mismatch in depth ranges may result in noise being added to the normalized application logs (e.g., a small bump being added to the normalized application probability distribution). Use of a weighting factor (w) in the well log normalization enables changes in relative contributions from different components (e.g., regions) of the reference probability distribution. The weighting factor (w) may increase, reduce, or remove a component of the reference probability distribution.

For example, in FIG. 5, a smaller bump on the left side of the reference probability distribution 502 may be removed and a larger bump on the right side of the reference probability distribution 502 may be increased using the weighting factor (w) for different components of the reference probability distribution 502 to generate a weighted reference probability distribution 504. Without reducing/decreasing regions of the reference probability distribution 502 that are not well represented in the normalized application probability distribution 512, well log normalization may stretch the normalized application probability distribution 512 to encompass the entirety of the reference probability distribution 502 when the application logs may include data from a subset of depths with respect to the reference logs.

Use of the weighting factor (w) may result in the weighted reference probability distribution 504 being a better approximation of the normalized application probability distribution 512 than the reference probability distribution 502. Use of the weighting factor (w) may result in the shape of the weighted reference probability distribution 504 being closer to the shape of the normalized application probability distribution 512 than the reference probability distribution 502. Use of the weighting factor (w) may result in more accurate well log normalization.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate well log normalization. The machine-readable instructions 100 may include one or more computer program components. The machine-readable instructions 100 may include an application log component 102, a reference log component 104, a normalization component 106, and/or other computer program components.

The application log component 102 may be configured to obtain application log information and/or other information. Obtaining application log information may include one or more of accessing, acquiring, analyzing, creating, determining, examining, generating, identifying, loading, locating, measuring, opening, receiving, retrieving, reviewing, selecting, storing, utilizing, and/or otherwise obtaining the application log information. The application log component 102 may obtain application log information from one or more locations. For example, the application log component 102 may obtain application log information from a storage location, such as the electronic storage 13, electronic storage of a device accessible via a network, and/or other locations. The application log component 102 may obtain application log information from one or more hardware components (e.g., a computing device, a component of a computing device) and/or one or more software components (e.g., software running on a computing device).

In some implementations, the application log information may be obtained from one or more users. For example, a user may interact with a computing device to input, upload, identify, and/or select the well logs to be normalized, and the application log information for the well logs may be obtained. The application log information may be stored within a single file or multiple files.

The application log information may define one or more sets of application logs. A set of application logs may include multiple application logs. A well log may refer to a measurement (versus depth and/or time) of one or more physical quantities in and/or around a well. A well log may be defined by a curve, with the shape and magnitude of the curve indicating one or more subsurface properties at different locations and/or times. An application log may refer to a well log that may be normalized using one or more reference logs. An application log may refer to a well log that is to be normalized. An application log may include a real well log or a synthetic (pseudo) well log. The application log information may define an application log by including information that defines one or more content, qualities, attributes, features, and/or other aspects of the application log. For example, the application log information may define an application log by including information that makes up the measured attributes in/around a well and/or information that is used to determine the measured attributes in/around the well. Other types of application log information are contemplated.

A set of application logs may include application mutable logs, application context logs, and/or other application logs. An application mutable log may refer to an application log to be changed in the well log normalization. An application mutable log may refer to a well log measurement that includes noise from wellbore conditions and/or operation factors, where the noise cannot be removed based on the wellbore conditions and/or the operation factors. An application mutable log may refer to a well log measurement that includes noise from wellbore conditions and/or operation factors, where the noise is removed via well log normalization. For example, the type and/or extent of noise generated in the well log measurement due to tool/tool calibration used for well log measurement may be unknown, and such noise may not be removed from the well log based on the identity of the tool that was used for well log measurement. Well log normalization may be required to remove such noise.

An application context log may refer to an application log not to be changed in the well log normalization. An application context log may refer to an application log that provides context for changing application mutable logs. An application context log may refer to a well log measurement that does not include noise from wellbore conditions and/or operation factors. An application context log may refer to a well log measurement that includes noise from wellbore conditions and/or operation factors, where the noise can be removed based on the wellbore conditions and/or the operation factors. An application context log may refer to a well log measurement that includes noise from wellbore conditions and/or operation factors, where the noise is removed without well log normalization. For example, the type and/or extent of noise generated in the well log measurement due to how the tool is used/environment in the tool is used for well log measurement may be known, and such noise may be removed from the well log based on how the tool was used/environment in the tool was used for well log measurement. Well log normalization may not be required to remove such noise.

In some implementations, the application log information may be derived from a single application well. An application well may refer to a well from which well log measurements require normalization. The application log information may define well logs measured from a single well. The application logs measured from a single well may be gathered within a single application dataset. The probability distribution of application logs measured from a single application well may be used in the well log normalization for the single application well.

In some implementations, obtaining the application log information may include identifying/classifying application mutable logs and application context logs within a set of application logs. The application mutable logs and the application context logs may be identified/classified based on the types of well logs. For example, certain types of well logs may be identified/classified as application mutable logs while other types of well logs may be identified as application context logs. For instance, gamma ray and neutron porosity logs may be identified/classified as application mutable logs while density and conductivity logs may be identified/classified as application context logs. The application logs may be required to have the same types of mutable logs and context logs as the reference logs.

The reference log component 104 may be configured to obtain reference log information and/or other information. Obtaining reference log information may include one or more of accessing, acquiring, analyzing, creating, determining, examining, generating, identifying, loading, locating, measuring, opening, receiving, retrieving, reviewing, selecting, storing, utilizing, and/or otherwise obtaining the reference log information. The reference log component 104 may obtain reference log information from one or more locations. For example, the reference log component 104 may obtain reference log information from a storage location, such as the electronic storage 13, electronic storage of a device accessible via a network, and/or other locations. The reference log component 104 may obtain reference log information from one or more hardware components (e.g., a computing device, a component of a computing device) and/or one or more software components (e.g., software running on a computing device).

In some implementations, the reference log information may be obtained from one or more users. For example, a user may interact with a computing device to input, upload, identify, and/or select the well logs to be used as reference for normalization of other well logs, and the reference log information for the well logs may be obtained. The reference log information may be stored within a single file or multiple files.

The reference log information may define one or more sets of reference logs. A set of reference logs may include multiple reference logs. A reference log may refer to a well log that may be used as a reference in normalizing one or more well logs. A reference log may refer to a well log to which other well log(s) may be normalized. A reference log may include a real well log or a synthetic (pseudo) well log. The reference log information may define a reference log by including information that defines one or more content, qualities, attributes, features, and/or other aspects of the reference log. For example, the reference log information may define a reference log by including information that makes up the measured attributes in/around a well and/or information that is used to determine the measured attributes in/around the well. Other types of reference log information are contemplated.

A set of reference logs may include reference mutable logs, reference context logs, and/or other reference logs. The reference mutable logs may correspond to the application mutable logs. The reference context logs may correspond to the application context logs. The set of reference logs may include the same type(s) of mutable logs as the set of application logs. The set of reference logs may include the same type(s) of context logs as the set of application logs.

In some implementations, the reference log information may be derived from one or more reference wells. A reference well may refer to a well from which well log measurements provide a reference for well log normalization of other well logs. Reference logs used to normalize well logs from an application well may come from a single reference well or multiple reference wells. The reference logs measured from reference well(s) may be gathered within a single reference dataset. The probability distribution of reference logs measured from reference well(s) may be used in the well log normalization for individual application wells.

In some implementations, obtaining the reference log information may include identifying/classifying reference mutable logs and reference context logs within a set of reference logs. The reference mutable logs and the reference context logs may be identified/classified based on the types of well logs. For example, certain types of well logs may be identified/classified as reference mutable logs while other types of well logs may be identified as reference context logs. For instance, gamma ray and neutron porosity logs may be identified/classified as reference mutable logs while density and conductivity logs may be identified/classified as reference context logs. The reference logs may be required to have the same types mutable logs and context logs as the application logs.

The normalization component 106 may be configured to generate one or more sets of normalized application logs. Generating a set of normalized application logs may include bringing about, calculating, creating, marking, producing, quantifying, and/or otherwise generating the set of normalized application logs. Generating a set of normalized application logs may include changing an existing set of application logs or creating a new set of application logs that have been normalized. A set of normalized application logs may include normalized application mutable logs, application context logs, and/or other application logs. Normalization of a set of application logs may change the application mutable logs while not changing the application context logs.

A set of normalized application logs may be generated based on a multivariate linear transformation of a set of application logs. A multivariate linear transformation of application logs may be performed in a higher dimension than a univariate linear transformation of the application logs. Performance of the multivariate linear transformation in the higher dimension may enable the multivariate linear transformation to achieve more complete transformation of the application logs than is possible using univariate linear transformation.

The multivariate linear transformation of a set of application logs may change the application mutable logs in the set of normalized application logs while not changing the application context logs in the set of normalized application logs. The multivariate linear transformation of a set of application logs may change the application mutable logs in the set of normalized application logs while keeping the application context logs constant in the in the set of normalized application logs.

The multivariate linear transformation of the set of application logs may be performed using a set of reference logs and/or other information. The set of reference logs may provide a goal for the multivariate linear transformation of the set of application logs. The multivariate linear transformation of the set of application logs may be performed by comparing the set of normalized application logs to the set of reference logs.

The multivariate linear transformation of a set of application logs may include an iterative loop in which the multivariate linear transformation (one or more parameters of the multivariate linear transformation) is adjusted based on comparison of the set of reference logs with the set of normalized application logs. The multivariate linear transformation (the parameter(s) of the multivariate linear transformation) may be adjusted based on comparison of a probability distribution of the set of reference logs with a probability distribution of the set of normalized application logs. The goal of the iterative loop may be to adjust the parameter(s) of the multivariate linear transformation to match (e.g., increase/maximize similarity) the normalized distribution of application logs to their counterparts in the distribution of reference logs. The goal of the iterative loop may be to adjust the parameter(s) of the multivariate linear transformation to match the normalized distribution of application mutable logs to their counterparts in the distribution of reference logs.

The parameter(s) of the multivariate linear transformation may be adjusted until the difference between the set of reference logs and the set of normalized application logs satisfy one or more criteria (e.g., the difference falls below a threshold value, the difference is the minimum difference). The parameter(s) of the multivariate linear transformation may be adjusted until the difference between the probability distribution of the set of reference logs and the probability distribution of the set of normalized application logs satisfy one or more criteria (e.g., the difference falls below a threshold value, the difference is the minimum difference).

In some implementations, the multivariate linear transformation of a set of application logs (the parameter(s) of the multivariate linear transformation) may be adjusted based on difference between a probability distribution of a set of normalized application logs and a probability distribution of a set of reference logs, and/or other information. The multivariate linear transformation of a set of application logs may be adjusted to reduce/minimize the difference between the probability distribution of the set of normalized application logs and the probability distribution of the set of reference logs.

In some implementations, the difference between the probability distribution of a set of normalized application logs and the probability distribution of a set of reference logs may be quantified using a symmetrized divergence, such as the Jensen-Shannon divergence. For example, the multivariate linear transformation of a set of application logs may be adjusted to reduce/minimize the value of Jensen-Shannon divergence between the probability distribution of the set of normalized application logs and the probability distribution of the set of reference logs. Use of other symmetrized divergence and difference between the probability distributions of the normalized application logs and reference logs is contemplated.

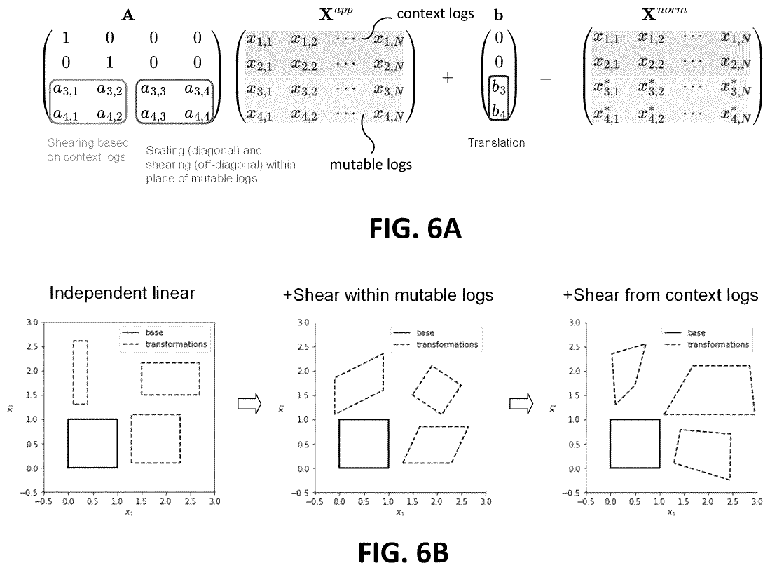

A set of application logs may be represented within a data matrix for the multivariate linear transformation. FIG. 6A illustrates an example multivariate linear transformation in which a set of application logs are represented within a data matrix. A set of application logs that includes d total well logs with N sampled depths may be arranged into an [d×N] data matrix, X^{app}, in which first d_{c} rows correspond to the application context logs while the next dₘ rows correspond to the application mutable logs (d=d_{c}+dₘ).

A set of normalized application logs (a normalized dataset, X^{norm}) may be generated by applying the multivariate linear transformation to the set of application logs (the application dataset, X^{app}). The set of normalized application logs may be represented within a matrix. The following multivariate linear transformation may be used, where A may be an [d×d] transformation matrix, b may be an [d×1] bias (translation) vector, 1_{N}_{^{app}} may be an [N^{app}×1] vector of 1s, and ′ may represent the matrix transposition operator.

X^{norm}=AX^{app}+b(1_{N}_{^{app}})′

In the multivariate linear transformation, the first d_{c} rows of the transformation matrix A may be equal to the first d_{c} rows of the [d×d] identity matrix, and the first d_{c} elements of the bias vector b may be 0. Use of these element values/constraints in the transformation matrix A and the bias vector b may result in the multivariate linear transformation not changing the values of the application context logs. The diagonal element values of the transformation matrix A may correspond to a linear scaling factor and the off-diagonal element values of the transformation matrix A may correspond to a rotation/shearing of the multidimensional probability distribution of the application logs.

A set of reference logs may be represented within a matrix to enable comparison with the set of normalized application logs (X^{norm}). A set of reference logs that includes d total well logs with N sampled depths may be arranged into an [d×N] data matrix, X^{ref}(e.g., see FIG. 4), in which first d_{c} rows correspond to the reference context logs while the next dₘ rows correspond to the reference mutable logs (d=d_{c}+dₘ). While the set of reference log may share the same logs, the set of reference logs and the set of application logs may have different sampled depths. Thus, the matrices representing the set of reference logs and the set of application logs may have different number of columns (depths).

Adjustment of the multivariate linear transformation of the set of application logs may include change in values of the transformation matrix A and/or the bias vector b. The values of the transformation matrix A and/or the bias vector b may be changed to reduce (e.g., minimize) the difference (e.g., Jensen-Shannon divergence) between the set of normalized application logs and the set of reference logs. The values of the transformation matrix A and/or the bias vector b may be changed to reduce the difference between the probability distribution of the set of normalized application logs and the probability distribution of the set of reference logs. Such change in the values of the transformation matrix A and/or the bias vector b may result in the multidimensional probability distributions of the normalized application logs and the reference application logs being more (e.g., maximally) similar to each other.

FIG. 6B illustrates example transformations. The example transformations shown in FIG. 6B are illustrative of transformations enabled by the multilinear linear transformation of the present disclosure. The multivariate linear transformation of the present disclosure may be performed in a higher dimension (having more terms) than a univariate linear transformation. The multivariate linear transformation may include independent linear transformation (stretching/translation restricted to one dimension, which is performed in univariate linear transformation), and shearing. The multivariate linear transformation may enable, shearing, rotating, and shifting in multiple dimensions to perform well log normalization. The multivariate linear transformation may enable shearing of mutable logs with respect to context logs. Changes in context logs may be prohibited by not allowing transformation (e.g., scale, translation, shearing) that result in change to the context logs during normalization. By including context logs in the matrix for multivariate linear transformation, more complex transformation of application logs may be enabled in the normalization. Inclusion of the context logs enables apparent non-linearities in the transformation when viewed in a 2D bivariate plots of mutable logs, since the transformation depends on “hidden” context logs.

In some implementations, the probability distributions of application logs, normalized application logs, and reference logs may be represented as sums of multiple elementary probability density functions. For example, the probability distribution of the set of normalized application logs may be represented as one sum of multiple elementary probability density functions and the probability distribution of the set of reference logs may be represented as another sum of multiple elementary probability density functions. An elementary probability density function may refer to a density of a continuous random variable. An elementary probability density function may refer to a kernel. An element probability density function may refer to a component of the probability distribution, with the sum of element probability density functions being equal to the total probability distribution.

Modeling of data as probability distributions may enable the difference between different probability distributions to be quantified using a divergence (e.g., relative entropy, Jensen-Shannon divergence). Modeling of data as probability distributions may enable comparison of density of points in one probability distribution with density of points in another probability distribution. Modeling of data as probability distributions may enable correspondence/equivalence to be established between densities of points in different probability distributions. Representation of the probability distributions as sums of multiple elementary probability density functions may provide flexibility and simplicity to model arbitrary shapes of data point clouds as a single probability distribution.

In some implementations, the probability distributions of application logs, normalized application logs, and reference logs may be represented as sums of multiple elementary probability density functions using Gaussian mixture modeling and/or other information. For example, the probability distributions of application logs, normalized application logs, and reference logs may be represented as sums of multiple elementary probability density functions using Gaussian mixture modeling and/or other information. Individual sums may include combination of multiple Gaussian components (e.g., Gaussian kernels). Each individual Gaussian component, k, may be a multivariate-normally distributed variable centered at mean μₖ with full covariance Σₖ. Individual sums may include a linearly weighted combination of K Gaussian components, such as provided below, where Σₖ₌₁^{K}=πₖ=1, and 0≤πₖ≤1∀k=1, 2, . . . , K:

$$f ( x ; \{ {π}_{k} \} , \{ {μ}_{k} \} , \{ {Σ}_{k} \} ) = {\sum }_{k = 1}^{K} {π}_{k} 𝒩 ( x \vert {μ}_{k} , {Σ}_{k} )$$

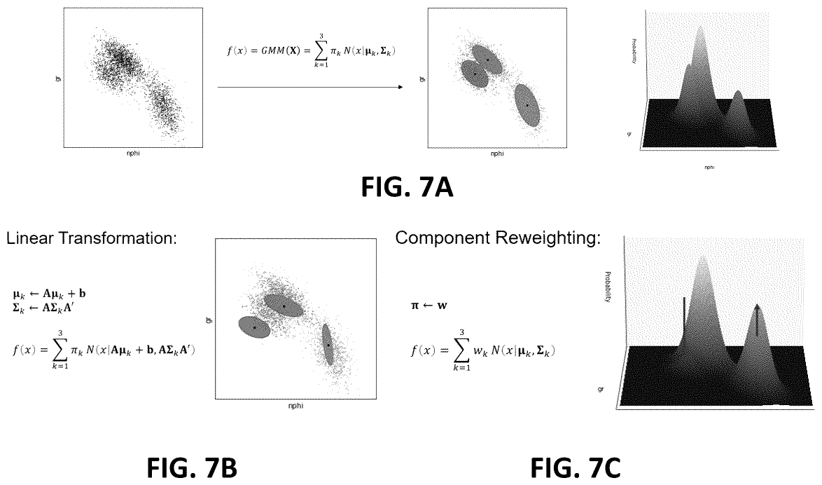

FIG. 7A illustrates an example representation of a probability distribution as a sum of multiple elementary probability distribution functions. FIG. 7A includes a cross plot of a gamma ray log and a neutron porosity log. The distribution of samples in the cross plot may be represented as a sum of three Gaussian components. The multivariate linear transformation may be used to linearly transform individual Gaussian components (e.g., change location of their means, translate them).

FIG. 7B illustrates an example multivariate linear transformation of the Gaussian components shown in FIG. 7A. Values of the transformation matrix A and the bias vector b may determine how individual Gaussian components are changed by the multivariate linear transformation. For example, in FIG. 7B, the sizes and location of individual Gaussian component may have been changed by the multivariate linear transformation.

In some implementations, components of a probability distribution of a set of reference logs may be reweighted to increase approximation of a probability distribution of a set of normalized application logs. Individual components of the reference probability distribution may be reweighted to better match the overall distribution of the normalized application logs. Weights of individuals component of the reference probability distribution may be modified to change (increase, reduce, or remove) the contribution of the components to the total probability distribution.

FIG. 7C illustrates an example component reweighting of a probability distribution. The probability distribution may have originally included three components, such as shown in FIG. 7A. The weight of one component (right-most component) may be increased while the weight of another component (left-most component) may be decreased to change the overall shape of the probability distribution. Reducing the weighting of a component of a probability distribution may include setting the weight of the component to zero to remove the component from the probability distribution. In some implementations, the weight of a component of a reference probability distribution may be set to zero based on a corresponding component not existing within a normalized application probability distribution. For example, in FIG. 7C, the weight of the left-most component may be set to zero to remove the left-most component from the reference probability distribution based on a similar component not existing within the application probability distribution. If the left-most component is not removed from the reference probability distribution, the left-most component may be erroneously added to the normalized application probability distribution.

Weighting the components of a reference probability distribution may enable the overall shape of the reference probability distribution to better match the overall shape of the normalized application probability distribution. Weighting the components of a reference probability distribution may prevent well log normalization from adding noise/error into the normalized logs.

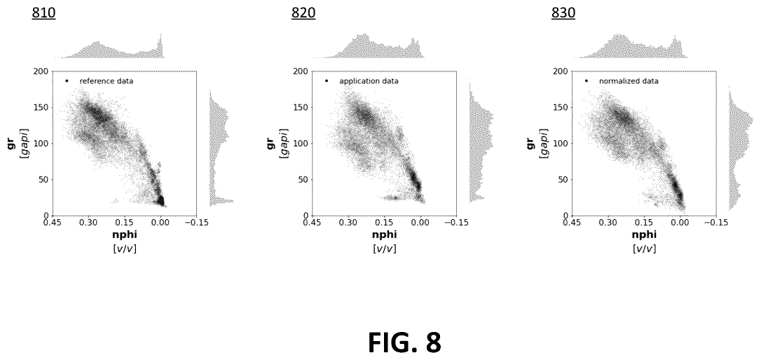

FIG. 8 illustrates an example well log normalization. FIG. 8 includes a reference data cross plot 810 and an application data cross plot 820 of gamma ray logs and neutron porosity logs. The application data may be normalized using the well log normalization technique described herein. A normalized data cross plot 830 includes a plot of normalized gamma ray log and normalized neutron porosity log.

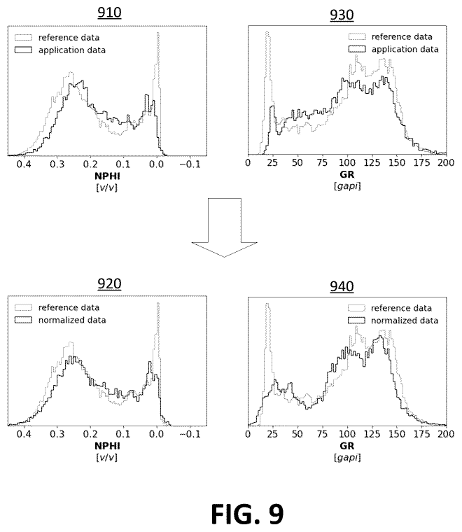

FIG. 9 illustrates example changes in probability distribution after well log normalization. FIG. 9 includes views 910, 920, 930, 940 of reference, application, and normalized probability distributions. The view 910 shows the probability distributions of neutron porosity reference data and neutron porosity application data. The probability distribution of the neutron porosity application data may be changed to the one shown in the view 920 based on usage of the normalization technique described herein. The view 920 shows the reference probability distribution and normalized application probability distribution of the neuron porosity data.

The view 930 shows the probability distributions of gammy ray reference data and gamma ray application data. The probability distribution of the gamma ray application data may be changed to the one shown in the view 940 based on usage of the normalization technique described herein. The view 940 shows the reference probability distribution and normalized application probability distribution of the gamma ray data.

In some implementations, information about well log normalization may be presented on the display 14. For example, one or more cross plots (e.g., such as shown in FIG. 8) and/or one or more probability distributions (e.g., such as shown in FIG. 9) of reference data, application data, and/or normalized application data may be presented on the display 14. In some implementations, cross plot(s) and/or probability distribution(s) may be used as a check to confirm that well log normalization is working properly. For example, the normalization technique of the present disclosure does not change context logs. Thus, cross plots and probability distributions of context logs before and after normalization should be the same. Differences between cross plots and/or probability distributions of context logs before and after normalization may be used to determine that well log normalization is not working properly.

The multivariate linear transformation technique of the present disclosure results in more accurate and more versatile normalization of well logs than univariate approaches. For example, the normalization technique of the present disclosure enables normalization that honors change to the underlying populations in the logs against intrinsic relationships with other logs. The normalization technique of the present disclosure enables accurate normalization even when well log preprocessing assumptions have been lost, as this information is inherited from context logs. Even if the well logs are preprocessed using inaccurate assumptions (e.g., incorrect assignment of the log's formation matrix), the normalization technique of the present disclosure may result in comparable outcome (e.g., data populations in right locations) as well logs preprocessed using accurate assumptions.

The normalization technique of the present disclosure enables normalization of application data using reference data when there is not a one-to-one match in data population distributions (e.g., due to geologic differences from which the application data and reference data were obtained). The normalization technique of the present disclosure enables normalization that captures both extreme populations in data as well as intermediate populations in data. The normalization technique of the present disclosure does not alter the application data to create populations present in reference data but not present in the application data.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

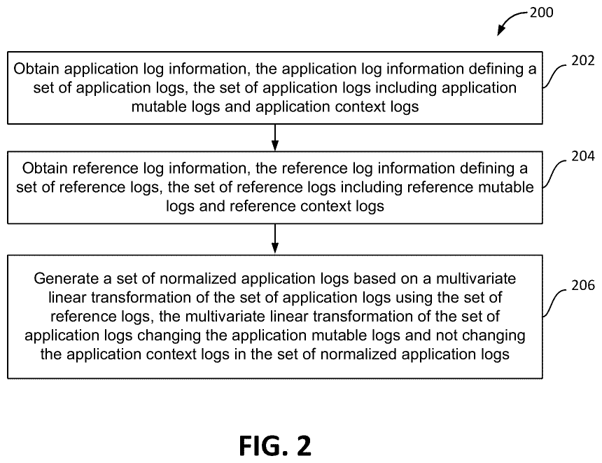

FIG. 2 illustrates method 200 for well log normalization. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, application log information may be obtained. The application log information may define a set of application logs. The set of application logs may include application mutable logs, application context logs, and/or other application logs. The application mutable logs may include application logs to be changed in the well log normalization. The application context logs may include application logs not to be changed in the well log normalization. In some implementation, operation 202 may be performed by a processor component the same as or similar to the application log component 102 (Shown in FIG. 1 and described herein).

At operation 204, reference log information may be obtained. The reference log information defining a set of reference logs. The set of reference logs may include reference mutable logs, reference context logs, and/or other reference logs. The reference mutable logs may correspond to the application mutable logs and the reference context logs may correspond to the application context logs. In some implementation, operation 204 may be performed by a processor component the same as or similar to the reference log component 104 (Shown in FIG. 1 and described herein).

At operation 206, a set of normalized application logs may be generated based on a multivariate linear transformation of the set of application logs using the set of reference logs and/or other information. The multivariate linear transformation of the set of application logs may change the application mutable logs in the set of normalized application logs. The multivariate linear transformation of the set of application logs may not change the application context logs in the set of normalized application logs. In some implementation, operation 206 may be performed by a processor component the same as or similar to the normalization component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for well log normalization, the system comprising:
one or more physical processors configured by machine-readable instructions to:
obtain application log information, the application log information defining a set of application logs, the set of application logs including application mutable logs and application context logs, the application mutable logs to be changed in the well log normalization and the application context logs not to be changed in the well log normalization;
obtain reference log information, the reference log information defining a set of reference logs, the set of reference logs including reference mutable logs and reference context logs, the reference mutable logs corresponding to the application mutable logs and the reference context logs corresponding to the application context logs; and
generate a set of normalized application logs based on a multivariate linear transformation of the set of application logs using the set of reference logs, the multivariate linear transformation of the set of application logs changing the application mutable logs and not changing the application context logs in the set of normalized application logs.

2. The system of claim 1, wherein the multivariate linear transformation of the set of application logs is adjusted based on difference between a probability distribution of the set of normalized application logs and a probability distribution of the set of reference logs.

3. The system of claim 2, wherein the set of application logs is represented within a data matrix for the multivariate linear transformation.

4. The system of claim 3, wherein adjustment of the multivariate linear transformation of the set of application logs includes change in values of a transformation matrix and/or a bias vector that reduces the difference between the probability distribution of the set of normalized application logs and the probability distribution of the set of reference logs.

5. The system of claim 4, wherein components of the probability distribution of the set of reference logs are reweighted to increase approximation of the probability distribution of the set of normalized application logs.

6. The system of claim 5, wherein reweighting of the components of the probability distribution of the set of reference logs to increase approximation of the probability distribution of the set of normalized application logs includes setting a weight of a given component of the probability distribution of the set of reference logs to zero to remove the given component based on a corresponding component not existing within the probability distribution of the set of normalized application logs.

7. The system of claim 2, wherein the difference between the probability distribution of the set of normalized application logs and the probability distribution of the set of reference logs is quantified using Jensen-Shannon divergence.

8. The system of claim 2, wherein the probability distribution of the set of normalized application logs and the probability distribution of the set of reference logs are represented as sums of multiple elementary probability density functions.

9. The system of claim 8, wherein the probability distribution of the set of normalized application logs and the probability distribution of the set of reference logs are represented as the sums of multiple elementary probability density functions using Gaussian mixture modeling.

10. The system of claim 1, wherein the application log information is derived from a single application well and the reference log information is derived from one or more reference wells.

11. A method for well log normalization, the method comprising:
obtaining application log information, the application log information defining a set of application logs, the set of application logs including application mutable logs and application context logs, the application mutable logs to be changed in the well log normalization and the application context logs not to be changed in the well log normalization;
obtaining reference log information, the reference log information defining a set of reference logs, the set of reference logs including reference mutable logs and reference context logs, the reference mutable logs corresponding to the application mutable logs and the reference context logs corresponding to the application context logs; and
generating a set of normalized application logs based on a multivariate linear transformation of the set of application logs using the set of reference logs, the multivariate linear transformation of the set of application logs changing the application mutable logs and not changing the application context logs in the set of normalized application logs.

12. The method of claim 11, wherein the multivariate linear transformation of the set of application logs is adjusted based on difference between a probability distribution of the set of normalized application logs and a probability distribution of the set of reference logs.

13. The method of claim 12, wherein the set of application logs is represented within a data matrix for the multivariate linear transformation.

14. The method of claim 13, wherein adjustment of the multivariate linear transformation of the set of application logs includes change in values of a transformation matrix and/or a bias vector that reduces the difference between the probability distribution of the set of normalized application logs and the probability distribution of the set of reference logs.

15. The method of claim 14, wherein components of the probability distribution of the set of reference logs are reweighted to increase approximation of the probability distribution of the set of normalized application logs.

16. The method of claim 15, wherein reweighting of the components of the probability distribution of the set of reference logs to increase approximation of the probability distribution of the set of normalized application logs includes setting a weight of a given component of the probability distribution of the set of reference logs to zero to remove the given component based on a corresponding component not existing within the probability distribution of the set of normalized application logs.

17. The method of claim 12, wherein the difference between the probability distribution of the set of normalized application logs and the probability distribution of the set of reference logs is quantified using Jensen-Shannon divergence.

18. The method of claim 12, wherein the probability distribution of the set of normalized application logs and the probability distribution of the set of reference logs are represented as sums of multiple elementary probability density functions.

19. The method of claim 18, wherein the probability distribution of the set of normalized application logs and the probability distribution of the set of reference logs are represented as the sums of multiple elementary probability density functions using Gaussian mixture modeling.

20. The method of claim 11, wherein the application log information is derived from a single application well and the reference log information is derived from one or more reference wells.
